(19) United States
(12) Patent Application Publication
(10) Pub. No.: US 2015/0379302 A1
(43) Pub. Date: Dec. 31, 2015

(54) PRIVACY ENHANCED EMAIL SERVICE

(71) Applicant: NED SMITH, Beaverton, OR (US)

(72) Inventor: NED SMITH, Beaverton, OR (US)

(21) Appl. No.: 14/314,652

(22) Filed: Jun. 25, 2014

(51) Int. Cl. G06F 21/62; G06F 7/58; H04L 12/58

(52) U.S. Cl. CPC G06F 21/6254; H04L 51/00; G06F 7/58; G06F 21/6263; G06F 2207/58

(57) ABSTRACT

Generally, this disclosure describes a system including a user device and a privacy service. The user device includes a random number generator module configured to generate a random number. The user device further includes an email account module configured to create a random email name based, at least in part, on the random number and to create a random email address including the random email name and a privacy domain name. The random email address is configured to be provided to a service provider.

### FIELD

This disclosure relates to email service, more particularly privacy enhanced email service.

### BACKGROUND

Web services providers often collect privacy sensitive account information as part of enrollment processes. Many sites utilize an email address as a user's account identifier. Identity thieves rely on this convention when performing an identity attack. For example, identity thieves may encourage users to create an account at a honeypot web service (i.e., a decoy web service used to monitor attackers). In another example, identity thieves may perform cross-site scripting attacks in order to obtain a user's email address. Once the user's email address is obtained, the attackers may perform a variety of undesirable attacks including hacking into high-value websites such as banking, health or financial accounts. They may sell the email address to spammers or use it to search online social media sites to gather additional privacy sensitive information.

Further, users typically maintain a small number of email accounts (and associated email addresses) and often reuse the same address when requested to enroll in a web site. A user's email address is typically included in an email header used for routing. A message portion of an email may be encrypted to protect the contents but not the header since the header is used for routing. A user may send and receive a number of emails using, e.g., one email account (and associated email address). By monitoring header information, a social graph may be created based, at least in part, on email addresses in the header of the number of emails. The social graph may then provide information that the user may not otherwise wish to share.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a system that includes user device and a privacy service consistent with various embodiments of the present disclosure;

FIG. 2 illustrates example email account records consistent with one embodiment of the present disclosure;

FIG. 3 illustrates example subscriber records consistent with one embodiment of the present disclosure;

FIG. 4 illustrates a flowchart of exemplary operations for an email account module consistent with various embodiments of the present disclosure; and

FIG. 5 illustrates a flowchart of exemplary operations for a privacy service consistent with various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes a system and method configured to enhance user privacy for communication with service providers that may utilize email addresses to identify a user. The method and system include a privacy service and a user device. The user device is configured to create a plurality of random email names based, at least in part, on a plurality of random numbers. The privacy service is configured to provide a privacy domain name that may be utilized by the user device to generate random email addresses that each include a respective random email name and the privacy domain name. The privacy domain name (e.g., privacy_domain) is configured to maintain a subscriber's (i.e., user's) privacy. In other words, the privacy domain name is configured to be utilized by a number of subscribers and to not compromise any subscriber's privacy. Each random email address may then be provided to a respective service provider and the random email name and associated service provider domain name may be provided to the privacy service. Thus, the user may be able to register with one or more service provider(s) while remaining generally anonymous.

Email communication(s) from the service providers may then be received by the privacy service and may or may not be provided to a user internal email address, based on policy. The user internal email address may be provided, for example, only to the privacy service and/or to entit(ies) trusted by the user. For example, emails from the service provider domain associated with the random email address may be provided while emails from other entities may not be provided.

When a user wishes to cease communication with a selected service provider, an email account (and/or record) associated with the email address provided to the selected service provider may be deleted by, or on behalf of, the user. Thus, using a system and method consistent with the present disclosure, a user may be able to stop receiving emails from a selected service provider by deleting the email account associated with the selected service provider without affecting communication with other entities (i.e., without deleting other email accounts).

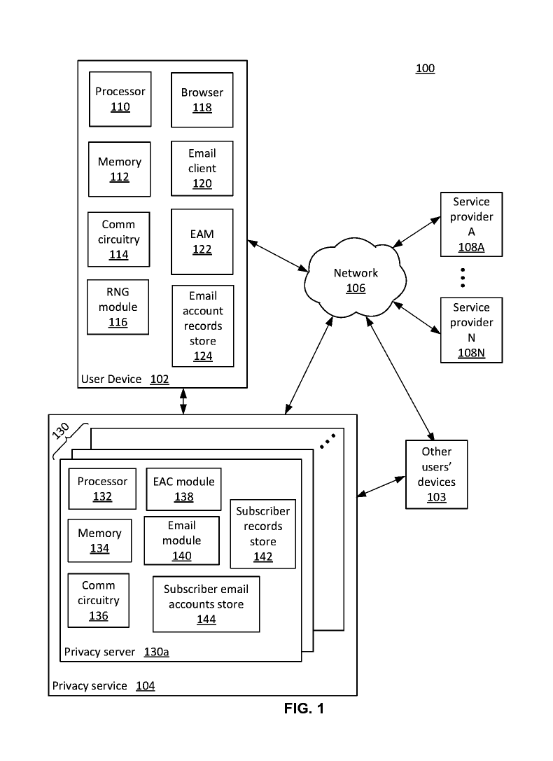

FIG. 1 illustrates a system 100 that includes a user device 102 and a privacy service 104 consistent with various embodiments of the present disclosure. The privacy service 104 includes a plurality of privacy servers 130, e.g., privacy server 130a. User device 102 may include computing devices including, but not limited to, desktop computers, laptop computers, tablet computers (e.g., iPad®, GalaxyTab® and the like), ultraportable computers, ultramobile computers, netbook computers, subnotebook computers, mobile telephones, smart phones, (e.g., iPhones®, Android®-based phones, Blackberries®, Symbian®-based phones, Palm®-based phones, etc.), feature phones, personal digital assistants, enterprise digital assistants, mobile internet devices, personal navigation devices, etc.

The system 100 may include network 106 configured to couple user device 102, privacy service 104 and/or one or more service provider(s) 108a, . . . , 108m. A service provider is an entity configured to provide one or more service(s) to a user. The service provider may utilize an email address to identify a user and/or a user account. For example, service(s) may include e-commerce, banking, information storage and/or retrieval (e.g., websites that may include both free and premium content), web services, etc. A web service is a system designed to support interoperable computing device-to-computing device communication over a network. Service providers may include “brick and mortar” entities that request user email addresses, etc. For example, a service provider may request a user email address as part of a registration process. The service provider may then utilize the user email address to communicate with and/or identify the user. The service provider may send the user a confirmation email requesting a response configured to verify that the email address is active.

User device 102 may include processor 110, memory 112, communication circuitry 114 and random number generator (RNG) module 116. Processor 110 is configured to perform operations associated with user device 102. Communication circuitry 114 is configured to communicate, wired and/or wirelessly, with privacy service 104, e.g., privacy server 130a, and/or service providers 108A, . . . , 108N, via network 106, using one or more communication protocols, as described herein.

Privacy server 130a may include processor 132, memory 134 and communication circuitry 136. Processor 132 is configured to perform operations associated with privacy server 130a. Communication circuitry 136 is configured to communicate, wired and/or wirelessly, with user device 102, and/or service providers 108A, . . . , 108N, via network 106, using one or more communication protocols, as described herein.

User device 102 may include a browser 118, an email client 120, an email account module (EAM) 122 and an email account records store 124. For example, memory 112 may be configured to store email account records store 124. Browser 118 may be utilized to find, select and/or interact with a service provider 108A, . . . , 108N. Browser 118 may be utilized to access privacy service 104. For example, browser 118 may include a web browser, e.g., Mozilla® Firefox®, Internet Explorer®, Google Chrome™, Opera™ and/or Safari®. Email client 120 may be utilized to access and/or manage a user email account, e.g., to compose, send, receive and/or read email messages. For example, email client 120 may be included in user device 102, e.g., Microsoft® Outlook®, Mozilla® Thunderbird®, etc. In another example, email client 120 may be included as a utility in browser 118 configured to access privacy service 104 for email operations.

EAM 122 is configured to manage creation and storage of a plurality of random email names. As used herein, a random email name is a string of characters (e.g., alphanumeric) created based, at least in part, on a random number. The random email name corresponds to a user name of a typical email address. A random email address includes a random email name and a privacy domain name. The privacy domain name (e.g., privacy_domain) may be provided by privacy service 104, as described herein.

EAM 122 is configured to create a random email name in response to a request to provide an email address from a service provider 108A, . . . , 108N, e.g., Service Provider A. For example, a user may utilize user device 102 and browser 118 to access Service Provider A via network 106. Service Provider A, via browser 118, may request that the user register with Service Provider A by providing an email address and a password. The email address may then serve as a user identifier with Service Provider A as well as a means for Service Provider A to communicate with the user. The browser 118 may then be configured to request an email address from EAM 122.

EAM 122 may be configured to request one or more random number(s) from RNG module 116. RNG module 116 may be configured to generate the random number(s) in response to the request from EAM 122 and/or to provide previously generated and stored random number(s). For example, RNG module may correspond to digital RNG (DRNG) module available from Intel® Corp. The DRNG is configured to generate random values that have even namespace distribution. In other words, a probability of duplicate values scales proportionately with a size of the random number. For example, a 256-bit value has a probability of collision (i.e., being a duplicate) on the order of one to one over 2²⁵⁶≈1.1579×10⁷⁷.

Of course, Intel® DRNG is only an example RNG module and other modules configured to generate random numbers and/or pseudorandom numbers may be utilized consistent with the present disclosure. If a pseudorandom number generator (PRNG) is used, collisions may occur, depending, at least in part, on characteristics of a seed number. A random seed number is configured to reduce a likelihood of collisions. For example, the DRNG may be configured to provide the seed number. In this example, RNG module 116 may include a PRNG module and a DRNG module.

EAM 122 may be further configured to convert the random number(s) into a string of characters. In an embodiment, the string of characters may be alphanumeric. For example, EAM 122 may configured to convert a plurality of 7-bit sequences of the random number(s) into ASCII (American Standard Code for Information Interchange) characters. Of course, converting a plurality of 7-bit sequences into ASCII characters in only one example of converting a random number into characters and other techniques configured to convert random numbers into characters (that may or may not be alphanumeric) may be utilized consistent with the present disclosure. A number of characters in an email name may be limited. For example, the maximum number of characters may be 64. In another example, the maximum number of characters may be 256. Two 256-bit random numbers may be used when creating a 64 ASCII character random email name from 7-bit sequences and seven 256-bit random numbers may be used when creating a 256 ASCII character random email name. The string of characters may then correspond to a random email name.

The EAM 122 is then configured to prepend the random email name (and @ sign) to the privacy domain name (e.g., privacy_domain) provided by privacy service 104 to create a random email address. For example, the privacy domain name may be provided when the user registers with privacy service 104, as described herein. The EAM 122 may then provide the random email address to browser 118 and capture Service Provider A domain from browser 118. In an embodiment, EAM 122 is configured to store the random email address and associated service provider domain name in the email account records store 124.

Service providers 108A, . . . , 108N may typically also request a user password to be associated with a user email address during registration. The user may provide the password and/or a password may be generated by a conventional password manager. Browser 118 may then provide the random email address and password to Service Provider A. Registration with Service Provider A may then be completed.

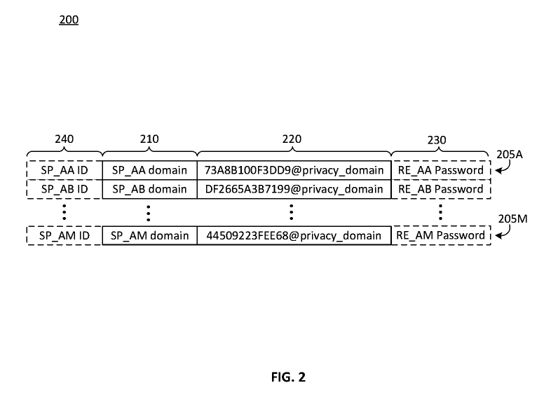

FIG. 2 illustrates example 200 email account records 205A, . . . , 205M consistent with one embodiment of the present disclosure. In this embodiment, EAM 122 is configured to store each random email address and associated service provider domain name in email account records store 124. Each email account record 205A, . . . , 205M includes a plurality of fields. Fields include service provider domain 210 and random email address 220 associated with the service provider domain. For example, record 205A includes Service Provider A domain name (i.e., SP_AA domain) and associated random email address 73A8B100F3DD9@privacy_domain. In this example, 73A8B100F3DD9 corresponds to a random email name. Records 205A, . . . , 205M may further include a password field 230 configured to store passwords associated with each random email address. Records may further include a service provider identifier (ID) field 240. The service provider ID field 240 may be utilized by a user to select a record based on the service provider ID. The service provider ID may be provided by the user and may be relatively more easily remembered by the user than the service provider domain name. The email account records 205A, . . . , 205M are configured to allow a user to communicate with service providers using registered random email addresses, as described herein.

In some embodiments, email account records 205A, . . . , 205M may include each random email name rather than the random email address. In these embodiments, EAM 122 may be configured to append the @ sign and the privacy domain name (e.g., privacy_domain) to each random email name prior to provision to, e.g., email client 120. In these embodiments, the privacy domain name may be stored once in email account records store 124.

If a user wishes to send an email to a service provider 108A, . . . , 108N, after registering with the service provider 108A, . . . , 108N, EAM 122 may be configured to interface with email client 120. For example, EAM 122 may request a target service provider ID from the user. In another example, EAM 122 may be configured to provide a list of service provider IDs, from which, the user may select the target service provider ID. In an example, EAM 122 may then provide the random email address associated with the target service provider ID to the email client 120 and configure the email client 120 with an email account that includes the provided random email address as a source address and a reply address for the communication with the target service provider. In another example, EAM 122 may be configured to rewrite the email message to the target service provider so that From and ReplyTo addresses use the random email address associated with the target service provider. Email client 120 may then couple to privacy service 104 and email module 140 (i.e., email server) to complete sending the email, as described herein.

EAM 122 is configured to provide each random email name and associated service provider domain name to privacy service 104, e.g., to privacy server 130a. For example, EAM 122 may be configured to automatically provide each random email name and associated service provider domain pair to privacy service 104. In this example, EAM 122 may be configured to provide the pair to privacy service 104 during registration and/or when registration completes. In another example, EAM 122 may be configured to provide the pair to privacy service 104 in response to a user request (e.g., selection). The user may select a random email name and associated service provider domain name pair from email account records store 124 and EAM 122 may then provide the selected pair to privacy service 104.

Thus, a plurality of random email names (and addresses) may be created and each random email name (and/or address) may be associated with a respective service provider domain. Communication with each of a plurality of service providers using a respective email address may then not provide information about user activities and/or communication with other service providers. Further, capture of one random email address and associated password may not provide information that could be used with other service providers. At least some protection may depend on the privacy service 104, the privacy domain name and/or a number of subscribers to the privacy service 104.

For example, each potential subscriber of a plurality of potential subscribers may select a privacy service based, at least in part, on a level of trust related to the privacy service. A level of trust greater than or equal to a trust threshold may result in a potential subscriber becoming an actual subscriber. The level of trust may be related to security techniques available and/or utilized by the security service configured to protect and/or properly isolate user records. For example, security techniques may include, but are not limited to, virtualization, separation kernels and/or secure enclave, HSM (hardware security module), TPM (Trusted Platform Module) and/or other hardware execution environments. A privacy service, e.g., privacy service 104, that is configured to provide a relatively higher level of trust may achieve a relatively larger number of subscribers. A relatively larger number of subscribers may enhance the level of privacy afforded by privacy service 104 since a relatively larger number of random email addresses may be associated with privacy service 104.

Privacy server 130a includes an email account concentrator (EAC) module 138, an email module 140, a subscriber records store 142 and a subscriber email account store 144. For example, memory 134 may be configured to store subscriber record store 142 and/or subscriber email account store 144. EAC module 138 is configured to create a subscriber account record (i.e., subscriber record) and to store the subscriber record in subscriber record store 142. For example, the subscriber record may be created in response to a user registering with (i.e., subscribing to) privacy service 104. EAC module 138 is further configured to receive the random email name and associated service provider domain name from EAM 122. EAC module 138 may be similarly configured to receive random email names and associated service provider domain names from a plurality of other users' devices 103 (i.e., other subscribers' devices). Each random email name and associated service provider domain name pair may also be associated with a subscriber identifier (ID). For example, the subscriber identifier may correspond to the subscriber's (i.e., user's) internal email address. In another example, the subscriber ID may correspond to an identifier provided when the subscriber registered with the privacy service 104.

EAC module 138 may store the received random email name and associated service provider domain name pair in subscriber records store 142 associated with the subscriber ID. EAC module 138 may create an email account using the random email name and privacy domain name as the sender's (and reply-to) email address and store the email account information in the subscriber email account store 144. In an embodiment, EAC module 138 may be configured to check for a collision (i.e., to determine whether the received random email name is the same as an existing random email name stored in subscriber records store 142). If a collision is detected, the pair may not be stored, the associated email account may not be created and the subscriber associated with the received pair may be notified.

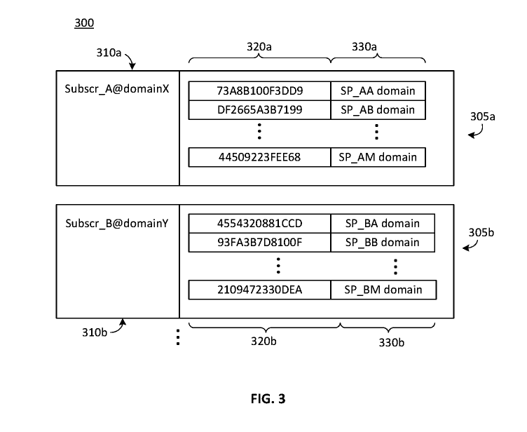

FIG. 3 illustrates one example 300 of subscriber records consistent with one embodiment of the present disclosure. Subscriber records store 142 is configured to store a plurality of subscriber records. The example 300 illustrates two example subscriber records 305a, 305b. Each subscriber record 305a, 305b includes a respective subscriber ID 310a, 310b. In this example, the subscriber IDs 310a, 310b correspond to the subscribers' internal email addresses. Each subscriber record 305a, 305b may include a random email name field 320a, 320b and an associated service provider domain field 330a, 330b. A subscriber record (e.g., record 305a) may include one or more entries in the two fields 320a, 330a with each entry corresponding to a random email name and service provider domain name pair (e.g., 73A8B100F3DD9 and SP_AA domain). Thus, one subscriber ID (e.g., subscriber ID 310a) may be associated with a plurality of random email name and service provider domain name pairs.

During and/or after registration, a service provider 108A, . . . , 108M, e.g., Service Provider A, may send an email to the random email address that was provided during the registration process. Sending during registration is configured to verify that the random email address provided is active. Emails with addresses that include the privacy domain name (e.g., privacy_domain) as the domain name may be routed to privacy service 104. Email module 140 may be configured to receive emails routed to privacy service 104 (and, e.g., privacy server 130a). For example, email module 140 may be configured to comply and/or be compatible with an SMTP (Simple Mail Transfer Protocol), as described herein. Email module 140 may be configured store the received email and notify EAC module 138. EAC module 138 is configured to retrieve the received email name (i.e., username) and the sender's domain name. EAC module 138 is further configured to determine whether the received email name exists in subscriber records store 142 and, if so, whether the sender's domain name is the same as the service provider domain name associated with the received email name.

In an embodiment, if the received email name does not exist in the subscriber records store 142, the EAC module 138 may be configured to wait for a time interval and then retry. For example, a user may provide the random email name, service provider domain name pair(s) to the privacy service 104 at some point after registering with the service provider. In another example, the user may not provide the random email name, service provider domain name pair(s) to the privacy service 104. In this example, the user may not wish to receive email communication from the service provider. The time interval (e.g., delay) may be configured to provide the user period of time in which to forward the pair. For example, the time interval may be on the order of minutes, hours and/or days. The time interval may be selected, e.g., by the user, during registration with the privacy service 104. If the received email name does not exist in the subscriber records store 142 after the time interval has expired and/or upon the retry, the received email may be deleted.

In an embodiment, if the received email name corresponds to an existing random email name and the sender's domain name does not correspond to the service provider's domain name associated with the existing random email name, the EAC module 138 is configured to select a response based on policy. For example, the policy and/or response may be determined during or after registration of the user with the privacy service 104. Responses may include, but are not limited to, discard the received email, provide the received email to the user's internal email address, notify the user, record the service provider's domain name and the sender's domain name, copy the email message (i.e., body) and/or provide the message to the user's internal email address. Recording the service provider's domain name and the sender's domain name is configured to allow the EAC module 138 to identify service provider(s) that share and/or sell user email addresses.

If the received email name corresponds to an existing random email name and the sender's domain name corresponds to the service provider's domain name associated with the existing random email name, the EAC module 138 is configured to identify the subscriber internal email address associated with the existing random email name. The EAC module 138 may then store the email and/or email message in the subscriber email account store 144 for retrieval by email client 120. The user may then access the email account store 144 using email client 120 and/or browser 118 to retrieve the email. Thus, the user may receive email communication from a service provider, e.g., Service Provider A, via privacy service 104.

In an embodiment, EAC module 138 may be configured to facilitate email communication from user device 102 to a selected service provider, e.g., Service Provider A, via privacy service 104. In this embodiment, the user may access privacy service 104 and EAC module 138 using browser 118. The EAC module 138 may then request that the user provide a target service provider domain name, e.g., Service Provider A domain name. The EAC module 138 may then identify the random email name associated with the Service Provider A domain name in subscriber records store 142 and create (i.e., form) a random email address that corresponds to the identified associated random email name. The EAC module 138 may then configure email client 120 with the created random email address as a reply address. Email client 120 may then provide the email to email module 140 for transmission to Service Provider A. For example, email module 140 may be configured to comply and/or be compatible with a POP (Post Office Protocol) and/or an IMAP (Internet Message Access Protocol), as described herein. An email (and/or message) may then be sent to Service Provider A using the created random email address as reply address.

When a user wishes to terminate a relationship with (e.g., cease communication entirely with) a service provider 108A, . . . , 108M, EAM 122 may be configured to remove the associated record from email account records store 124 in response to a user selection (i.e., command) and to notify privacy service 104 and EAC module 138. EAC module 138 may then remove the entries in the user's subscriber record related to the selected service provider. EAC module 138 may further delete the associated subscriber email account record (if any) from subscriber email accounts store 144. For example, the notification may include the selected service provider domain name. Records associated with other service providers may be unaffected by the removal of the record related to the selected service provider.

Thus, a system consistent with the present disclosure is configured to facilitate user privacy when registering and/or communicating with a plurality of service providers. The system is configured to create and store a plurality of random email addresses with each email address associated with a respective service provider. The random email addresses may then be used for registering and/or communicating with the service providers. Email communications from the service providers may be routed to a privacy service that is then configured to provide selected emails to the user. When the user wishes to terminate a relationship with a selected service provider, the system is configured to delete the email record and/or email account associated with the selected service provider. Thus, user privacy may be preserved and the user may control communications with service providers.

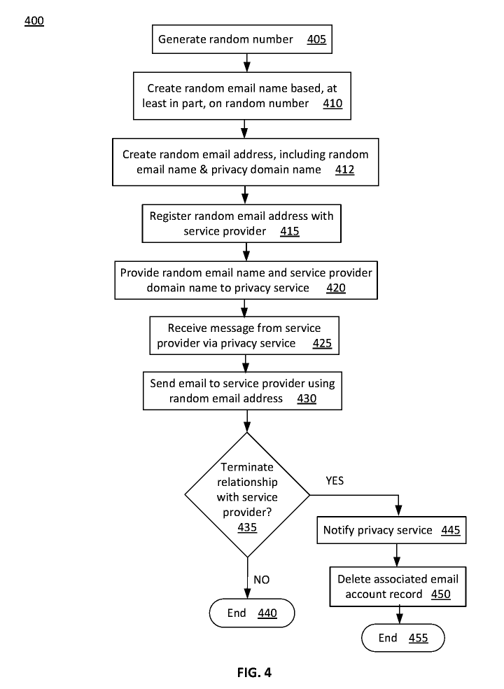

FIG. 4 illustrates an flowchart 400 of exemplary operations consistent with an embodiment of the present disclosure. The operations may be performed, for example, by user device 102. In particular, flowchart 400 depicts exemplary operations of the user device configured to create and use a random email address.

The operations of flow chart 400 may begin at operation 405 that includes generating a random number. A random email name may be created based, at least in part, on the random number at operation 410. A random email address including the random email name and a privacy domain name may be created at operation 412. Operation 415 includes registering the random email address with a service provider. Operation 420 includes providing the random email name and service provider domain name to a privacy service. A message may be received from a service provider via the privacy service at operation 425. An email may be sent to the service provider using a random email address at operation 430. Whether to terminate a relationship with the service provider may be determined at operation 435. If the relationship is not terminated, program flow may end at operation 440. If the relationship is terminated, the privacy service may be notified at operation 445. An associated email account record may be deleted at operation 450. Program flow may then end at operation 455.

Thus, a random email name may be created based on a random number. The random email name may be used with a privacy domain name to form a random email address. The random email address may be registered with a service provider and used for communication between a user device and the service provider. The relationship between the user device and the service provider may be terminated by the user by deleting the associated email account without affecting other email accounts.

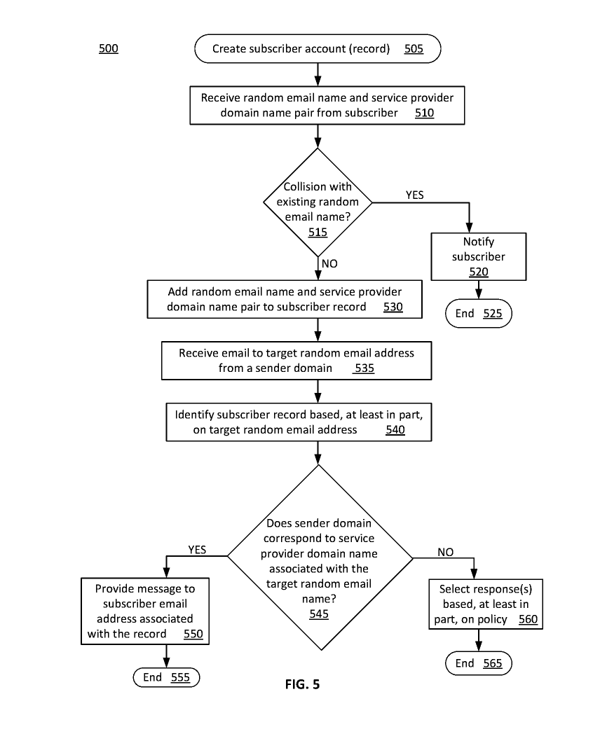

FIG. 5 illustrates a flowchart 500 of exemplary operations consistent with an embodiment of the present disclosure. The operations may be performed, for example, by privacy service 104 and/or privacy server 130a. In particular, flowchart 500 depicts exemplary operations of the privacy service configured to create and maintain subscriber records that include user random email addresses and associated service provider domain names.

The operations of flow chart 500 may begin at operation 505 that includes creating a subscriber record. A random email name and service provider domain name pair may be received from the subscriber at operation 510. Whether there is a collision with an existing random email name may be determined at operation 515. If there is a collision (i.e., the received random email name is the same as an existing random email name), the subscriber may be notified at operation 520. Program flow may then end at operation 525.

If there is not a collision, the random email name and service provider domain name may be added to the subscriber record at operation 530. An email to a target random email address may be received from a sender domain at operation 535. Operation 540 may include identifying a subscriber record based, at least in part, on the target random email address. Whether the sender domain corresponds to the service provider domain name associated with the target random email name may be determined at operation 545. If the sender domain corresponds to the service provider domain name associated with the target random email name, the message may be provided to a subscriber email address (e.g., subscriber internal email address) associated with the record at operation 550. Program flow may then end at operation 555. If the sender domain does not correspond to the service provider domain name associated with the target random email name, one or more response(s) may be selected based, at least in part, on policy at operation 560. Program flow may end at operation 565.

Thus, a privacy service may be configured to maintain a plurality of subscriber records that include random email name and service provider domain name pairs and to route (or not) received emails based, at least in part, on whether the sender of a received email corresponds to the service provider domain name associated with the received email address.

While the flowcharts of FIGS. 4 and 5 illustrate operations according to various embodiments, it is to be understood that not all of the operations depicted in FIGS. 4 and/or 5 are necessary for other embodiments. In addition, it is fully contemplated herein that in other embodiments of the present disclosure, the operations depicted in FIGS. 4 and/or 5, and/or other operations described herein may be combined in a manner not specifically shown in any of the drawings, and such embodiments may include less or more operations than are illustrated in FIGS. 4 and/or 5. Thus, claims directed to features and/or operations that are not exactly shown in one drawing are deemed within the scope and content of the present disclosure.

The foregoing provides example system architectures and methodologies, however, modifications to the present disclosure are possible. For example, user device 102 and/or privacy servers 130 may also include chipset circuitry. Chipset circuitry may generally include “North Bridge” circuitry (not shown) to control communication between a processor, I/O circuitry and memory.

User device 102 and/or privacy servers 130 may each further include an operating system (OS) to manage system resources and control tasks that are run on each respective device and/or system. For example, the OS may be implemented using Microsoft® Windows®, HP-UX®, Linux®, UNIX®, Android™, iOS® or Windows Phone®, although other operating systems may be used. In some embodiments, the OS may be replaced by a virtual machine monitor (or hypervisor) which may provide a layer of abstraction for underlying hardware to various operating systems (virtual machines) running on one or more processing units.

The operating system and/or virtual machine may implement one or more protocol stacks. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network. A protocol stack may alternatively be comprised on a dedicated sub-system such as, for example, a TCP offload engine and/or I/O circuitry. The TCP offload engine circuitry may be configured to provide, for example, packet transport, packet segmentation, packet reassembly, error checking, transmission acknowledgements, transmission retries, etc., without the need for host CPU and/or software involvement.

User device 102 and/or privacy service 104 may communicate with each other, via network 106 using a switched fabric communications protocol, for example, an Ethernet communications protocol, Infiniband communications protocol, etc. The Ethernet communications protocol may be capable of providing communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard, for example, the IEEE 802.3 Standard for Ethernet, published 2012. The Infiniband protocol may comply or be compatible with the Infiniband specification published by the InfiniBand Trade Association (IBTA), titled “InfiniBand™ Architecture Specification”, Volume 1, Release 1.2.1, published June 2001 and/or later versions of this specification, for example, InfiniBand™ Architecture, Volume 1 (General Specification), Release 1.2.1, published January 2008 and Volume 2 (Physical Specification), Release 1.3, published November 2012. Of course, in other embodiments, the switched fabric communications protocol may include a custom and/or proprietary switched fabric communications protocol.

Memory 112 and/or memory 134 may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may comprise other and/or later-developed types of machine-readable memory.

Embodiments of the operations described herein may be implemented in a computer-readable storage devices having stored thereon instructions that when executed by one or more processors perform the methods. The processor may include, for example, a processing unit and/or programmable circuitry. The storage device may include a machine-readable storage medium including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. “Module”, as used herein, may comprise, singly or in any combination circuitry and/or code and/or instructions sets (e.g., software, firmware, etc.).

In some embodiments, a hardware description language may be used to specify circuit and/or logic implementation(s) for the various modules and/or circuitry described herein. For example, in one embodiment the hardware description language may comply or be compatible with a very high speed integrated circuits (VHSIC) hardware description language (VHDL) that may enable semiconductor fabrication of one or more circuits and/or modules described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

User device 102 may be configured to communicate with network 106 and/or privacy service 104 using a variety of communication protocols. The communications protocols may include but are not limited to wireless communications protocols, such as Wi-Fi, 3G, 4G and/or other communication protocols. The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

Email module 140 may be configured to send and/or receive email communications using one or more email protocols. The email protocols may include, but are not limited to, SMTP, POP (e.g., POP3) and/or IMAP. The SMTP protocol may comply or be compatible with RFC 5321, published by the Internet Engineering Task Force (IETF), titled “Simple Mail Transport Protocol”, published October 2008, and/or later and/or related versions of this standard. The POP protocol may comply or be compatible with RFC 1939 published by IETF, titled “Post Office Protocol, Version 3”, published May 1996, and/or later and/or related versions of this standard. The IMAP protocol may comply or be compatible with RFC 3501 published by IETF, titled “Internet Message Access Protocol, Version 4, Revision 1”, published March 2003, and/or later and/or related versions of this standard.

Thus, the present disclosure provides a method and system configured to enhance user privacy for communication with service providers that may utilize email addresses to identify a user. The method and system include a privacy service and a user device. The user device is configured to create a plurality of random email names based, at least in part, on a plurality of random numbers. The privacy service is configured to provide a privacy domain name that may be utilized by the user device to generate random email addresses that each include a respective random email name and the privacy domain name. The privacy domain name (e.g., privacy_domain) is configured to maintain a subscriber's privacy. In other words, the privacy domain name is configured to be utilized by a number of subscribers and to not compromise any subscriber's privacy. Each random email address may then be provided to a respective service provider and the random email name and associated service provider domain name may be provided to the privacy service. Thus, the user may be able to register with one or more service provider(s) while remaining generally anonymous.

Email communication(s) from the service providers may then be received by the privacy service and may or may not be provided to a user internal email address, based on policy. The user internal email address may be provided, for example, only to the privacy service and/or to entit(ies) trusted by the user. For example, emails from the service provider domain associated with the random email address may be provided while emails from other entities may not be forwarded.

When a user wishes to cease communication with a selected service provider, an email account associated with the email address provided to the selected service provider may be deleted by, or on behalf of, the user. Thus, using a system and method consistent with the present disclosure, a user may be able to stop receiving emails from a selected service provider by deleting the email account associated with the selected service provider without affecting communication with other entities.

### EXAMPLES

Examples of the present disclosure include subject material such as a method, means for performing acts of the method, a device, at least one machine-readable device, including instructions that when performed by a machine cause the machine to perform acts of the method, or of an apparatus or system to enhance user privacy for communication with service providers that may utilize email addresses to identify a user, as discussed below.

### Example 1

According to this example there is provided a user device including a random number generator module configured to generate a random number; and an email account module configured to create a random email name based, at least in part, on the random number and to create a random email address including the random email name and a privacy domain name, wherein the random email address is configured to be provided to a service provider.

### Example 2

This example includes the elements of example 1 and further includes a browser configured to provide the random email address to the service provider during a registration process.

### Example 3

This example includes the elements of one of examples 1 and 2, and further includes an email client configured to receive an email communication from the service provider via a privacy service related to the privacy domain name.

### Example 4

This example includes the elements of any one of examples 1 to 3, and further includes a memory configured to store an email accounts records store, wherein the email account module is configured to store the random email name and a service provider domain name in the email account records store.

### Example 5

This example includes the elements of example 4, wherein the email account module is configured to delete a record including the random email name and the service provider domain name in response to a user request to terminate a relationship with the service provider.

### Example 6

This example includes the elements of any one of examples 1 to 5, wherein the email account module is configured to provide the random email name and a service provider domain name to a privacy service.

### Example 7

This example includes the elements of example 6, wherein the email account module is configured to provide the random email name and the service provider domain name to the privacy service at least one of during registration with the service provider and in response to a user request.

### Example 8

This example includes the elements of any one of examples 1 to 7, wherein the random number generator module includes at least one of a digital random number generator module and a pseudorandom number generator module.

### Example 9

According to this example there is provided a privacy service including a privacy server including: a subscriber records store; and an email account concentrator module configured to create a subscriber account record in response to a user registering with the privacy service. The email account concentrator module is further configured to receive a random email name and a service provider domain name from a user device. The random email name was created, based at least in part, on a random number and the random email name is configured to be included in a random email address.

### Example 10

This example includes the elements of example 9, wherein the email account concentrator module is configured to notify the user device if the received random email name is the same as an existing random email name stored in the subscriber records store.

### Example 11

This example includes the elements of one of examples 9 and 10, wherein the email account concentrator module configured to store the random email name and the service provider domain name in a subscriber record in the subscriber records store if no existing random email name stored in the subscriber records store is the same as the received random email name.

### Example 12

This example includes the elements of any one of examples 9 to 11, wherein the privacy server further includes an email module configured to receive an email to a target random email address from a sender domain. The target random email address includes a target random email name and a privacy domain name and the privacy domain name is related to the privacy service. The email account concentrator module is further configured to identify a target subscriber record based, at least in part, on the target random email name.

### Example 13

This example includes the elements of any one of examples 9 to 12, wherein the email account concentrator module is configured to select a response based, at least in part, on policy if the sender domain does not correspond to a target service provider domain name associated with the target random email name and to provide the received email to a target subscriber email address associated with the target subscriber record if the sender domain corresponds to a target service provider domain name associated with the target random email name.

### Example 14

This example includes the elements of any one of examples 9 to 13, wherein the received email includes an email message and the response includes one or more of discarding the received email, providing the received email to a user's internal email address, notifying the user, recording the target service provider domain name and the sender domain name, copying the email message and providing the email message to the user's internal email address.

### Example 15

This example includes the elements of any one of examples 9 to 14, wherein the email account concentrator module is configured to wait for a time interval and then retry identifying the target subscriber record if the target random email name does not exist in the subscriber records store.

### Example 16

This example includes the elements of any one of examples 9 to 15, wherein the email account concentrator module is configured to delete the random email name and the service provider domain name from the subscriber record in the subscriber records store in response to a notice from the user device.

### Example 17

This example includes the elements of any one of examples 9 to 16, wherein the subscriber records store includes a plurality of other subscriber records and each other subscriber record is associated with a respective subscriber identifier.

### Example 18

This example includes the elements of any one of examples 9 to 17, wherein the respective subscriber identifier corresponds to a respective subscriber internal email address.

### Example 19

According to this example there is provided a computer readable storage device having stored thereon instructions that when executed by one or more processors result in the following operations including: generating a random number; creating a random email name based, at least in part, on the random number; creating a random email address including the random email name and a privacy domain name; and

providing the random email address to a service provider.

### Example 20

This example includes the elements of example 19, wherein the instructions that when executed by one or more processors results in the following additional operations including: providing the random email name and a service provider domain name to a privacy service.

### Example 21

This example includes the elements of one of examples 19 and 20, wherein the instructions that when executed by one or more processors results in the following additional operations including: storing the random email name and a service provider domain name in an email account records store.

### Example 22

This example includes the elements of any one of examples 19 to 21, wherein the instructions that when executed by one or more processors results in the following additional operations including: notifying the privacy service and deleting the random email name and the service provider domain name from the email account records store in response to a user request to terminate a relationship with the service provider.

### Example 23

This example includes the elements of any one of examples 19 to 22, wherein the instructions that when executed by one or more processors results in the following additional operations including: receiving a message from the service provider via the privacy service.

### Example 24

This example includes the elements of any one of examples 19 to 23, wherein the random email name and the service provider domain name are provided to the privacy service at least one of during registration with the service provider and in response to a user request.

### Example 25

This example includes the elements of any one of examples 19 to 24, wherein the random number has even namespace distribution.

### Example 26

According to this example there is provided a computer readable storage device having stored thereon instructions that when executed by one or more processors result in the following operations including: creating a subscriber record in a subscriber record store in response to a user registering with a privacy service; and receiving a random email name and a service provider domain name. The random email name was created, based at least in part, on a random number and the random email name is configured to be included in a random email address.

### Example 27

This example includes the elements of example 26, wherein the instructions that when executed by one or more processors results in the following additional operations including: notifying a user device if the received random email name is the same as an existing random email name stored in the subscriber records store.

### Example 28

This example includes the elements of one of examples 26 and 27, wherein the instructions that when executed by one or more processors results in the following additional operations including: storing the random email name and the service provider domain name in the subscriber record in the subscriber record store if no existing random email name stored in the subscriber records store is the same as the received random email name.

### Example 29

This example includes the elements of any one of examples 26 to 28, wherein the instructions that when executed by one or more processors results in the following additional operations including: receiving an email to a target random email address from a sender domain, the target random email address including a target random email name and a privacy domain name; and identifying a target subscriber record based, at least in part, on the target random email name.

### Example 30

This example includes the elements of any one of examples 26 to 29, wherein the instructions that when executed by one or more processors results in the following additional operations including: providing the received email to a target subscriber email address associated with the target subscriber record if the sender domain corresponds to a target service provider domain name associated with the target random email name or selecting a response based, at least in part, on policy if the sender domain does not correspond to the target service provider domain name associated with the target random email name.

### Example 31

This example includes the elements of any one of examples 26 to 30, wherein the received email includes an email message and the response includes one or more of discarding the received email, providing the received email to a user's internal email address, notifying the user, recording the target service provider domain name and the sender domain name, copying the email message and providing the email message to the user's internal email address.

### Example 32

This example includes the elements of any one of examples 26 to 31, wherein the instructions that when executed by one or more processors results in the following additional operations including: waiting for a time interval and then retrying identifying the target subscriber record if the target random email name does not exist in the subscriber records store.

### Example 33

This example includes the elements of any one of examples 26 to 32, wherein the instructions that when executed by one or more processors results in the following additional operations including: deleting the random email name and the service provider domain name from the subscriber record in the subscriber records store in response to a notice from a user device.

### Example 34

Another example of the present disclosure is a method including: generating a random number by a random number generator module of a user device; creating, by an email account module of the user device, a random email name based, at least in part, on the random number; creating, by the email account module, a random email address including the random email name and a privacy domain name; and providing, by the email account module, the random email address to a service provider.

### Example 35

This example includes the elements of example 34, further including: providing, by the email account module, the random email name and a service provider domain name to a privacy service.

### Example 36

This example includes the elements of one of examples 34 and 35, further including: storing, by the email account module, the random email name and a service provider domain name in an email account records store.

### Example 37

This example includes the elements of any one of examples 34 to 36, further including: notifying the privacy service and deleting, by the email account module, the random email name and the service provider domain name from the email account records store in response to a user request to terminate a relationship with the service provider.

### Example 38

This example includes the elements of any one of examples 34 to 37, further including: receiving, by an email client of the user device, a message from the service provider via the privacy service.

### Example 39

This example includes the elements of any one of examples 34 to 38, wherein the email account module is configured to provide the random email name and the service provider domain name to the privacy service at least one of during registration with the service provider and in response to a user request.

### Example 40

This example includes the elements of any one of examples 34 to 39, wherein the random number has even namespace distribution.

### Example 41

Another example of the present disclosure is a method including: creating, by an email account concentrator module of a privacy server, a subscriber record in a subscriber record store in response to a user registering with a privacy service; and receiving, by the email account concentrator module, a random email name and a service provider domain name. The random email name was created, based at least in part, on a random number and the random email name is configured to be included in a random email address.

### Example 42

This example includes the elements of example 41, further including: notifying, by the email account concentrator module, a user device if the received random email name is the same as an existing random email name stored in the subscriber records store.

### Example 43

This example includes the elements of one of examples 41 and 42, further including: storing, by the email account concentrator module, the random email name and the service provider domain name in the subscriber record in the subscriber record store of the privacy server if no existing random email name stored in the subscriber records store is the same as the received random email name.

### Example 44

This example includes the elements of any one of examples 41 to 43, further including: receiving, by an email module of the privacy server, an email to a target random email address from a sender domain, the target random email address including a target random email name and a privacy domain name; and identifying, by the email account concentrator module, a target subscriber record based, at least in part, on the target random email name.

### Example 45

This example includes the elements of any one of examples 41 to 44, further including: providing, by the email account concentrator module, the received email to a target subscriber email address associated with the target subscriber record if the sender domain corresponds to a target service provider domain name associated with the target random email name or selecting a response based, at least in part, on policy if the sender domain does not correspond to the target service provider domain name associated with the target random email name.

### Example 46

This example includes the elements of any one of examples 41 to 45, wherein the received email includes an email message and the response includes one or more of discarding the received email, providing the received email to a user's internal email address, notifying the user, recording the target service provider domain name and the sender domain name, copying the email message and providing the email message to the user's internal email address.

### Example 47

This example includes the elements of any one of examples 41 to 46, further including: waiting, by the email account concentrator module, for a time interval and then retrying identifying the target subscriber record if the target random email name does not exist in the subscriber records store.

### Example 48

This example includes the elements of any one of examples 41 to 47, further including: deleting, by the email account concentrator module, the random email name and the service provider domain name from the subscriber record in the subscriber records store in response to a notice from a user device.

### Example 49

Another example of the present disclosure is a system including at least one device arranged to perform the method of any one of examples 34 to 39.

### Example 50

Another example of the present disclosure is a system including at least one device arranged to perform the method of any one of examples 41 to 48.

### Example 51

Another example of the present disclosure is a computer readable storage device having stored thereon instructions that when executed by one or more processors result in the following operations including: the method according to any one of examples 34 to 39.

### Example 52

Another example of the present disclosure is a computer readable storage device having stored thereon instructions that when executed by one or more processors result in the following operations including: the method according to any one of examples 41 to 48.

### Example 53

Another example of the present disclosure is a device including means to perform the method of any one of examples 34 to 39.

### Example 54

Another example of the present disclosure is a device including means to perform the method of any one of examples 41 to 48.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A user device comprising:
a random number generator module configured to generate a random number; and
an email account module configured to create a random email name based, at least in part, on the random number and to create a random email address comprising the random email name and a privacy domain name,
wherein the random email address is configured to be provided to a service provider.

2. The user device of claim 1, further comprising:
an email client configured to receive an email communication from the service provider via a privacy service related to the privacy domain name.

3. The user device of claim 1, further comprising:
a memory configured to store an email accounts records store,
wherein the email account module is configured to store the random email name and a service provider domain name in the email account records store.

4. The user device of claim 3, wherein the email account module is configured to delete a record comprising the random email name and the service provider domain name in response to a user request to terminate a relationship with the service provider.

5. The user device of claim 1, wherein the random number generator module comprises at least one of a digital random number generator module and a pseudorandom number generator module.

6. A privacy service comprising:
a subscriber records store; and
an email account concentrator module configured to create a subscriber account record in response to a user registering with the privacy service,
the email account concentrator module further configured to receive a random email name and a service provider domain name from a user device,
the random email name created, based at least in part, on a random number, the random email name configured to be included in a random email address.

7. The privacy service of claim 6, wherein the email account concentrator module is configured to notify the user device if the received random email name is the same as an existing random email name stored in the subscriber records store.

8. The privacy service of claim 6, wherein the email account concentrator module is configured to store the random email name and the service provider domain name in a subscriber record in the subscriber records store if no existing random email name stored in the subscriber records store is the same as the received random email name.

9. The privacy service of claim 8, wherein the privacy server further comprises:
an email module configured to receive an email to a target random email address from a sender domain, the target random email address comprising a target random email name and a privacy domain name, the privacy domain name related to the privacy service,
the email account concentrator module further configured to identify a target subscriber record based, at least in part, on the target random email name and
the email account concentrator module further configured to select a response based, at least in part, on policy if the sender domain does not correspond to a target service provider domain name associated with the target random email name and to provide the received email to a target subscriber email address associated with the target subscriber record if the sender domain corresponds to the target service provider domain name associated with the target random email name.

10. The privacy service of claim 8, wherein the email account concentrator module is configured to delete the random email name and the service provider domain name from the subscriber record in the subscriber records store in response to a notice from the user device.

11. A machine readable storage device having stored thereon instructions that when executed by one or more processors result in the following operations comprising:
generating a random number;
creating a random email name based, at least in part, on the random number;
creating a random email address comprising the random email name and a privacy domain name; and
providing the random email address to a service provider.

12. The system of claim 11, wherein the instructions that when executed by one or more processors results in the following additional operations comprising:
storing the random email name and a service provider domain name in an email account records store; and
providing the random email name and the service provider domain name to a privacy service.

13. The system of claim 12, wherein the instructions that when executed by one or more processors results in the following additional operations comprising:
notifying the privacy service and deleting the random email name and the service provider domain name from the email account records store in response to a user request to terminate a relationship with the service provider.

14. The system of claim 12, wherein the instructions that when executed by one or more processors results in the following additional operations comprising:
receiving a message from the service provider via the privacy service.

15. The system of claim 11, wherein the random number has even namespace distribution.

16. A machine readable storage device having stored thereon instructions that when executed by one or more processors result in the following operations comprising:
creating a subscriber record in response to a user registering with a privacy service; and
receiving a random email name and a service provider domain name, the random email name created, based at least in part, on a random number, the random email name configured to be included in a random email address.

17. The system of claim 16, wherein the instructions that when executed by one or more processors results in the following additional operations comprising:
notifying a user device if the received random email name is the same as an existing random email name stored in the subscriber records store.

18. The system of claim 16, wherein the instructions that when executed by one or more processors results in the following additional operations comprising:
storing the random email name and the service provider domain name in a subscriber record in a subscriber record store if no existing random email name stored in the subscriber records store is the same as the received random email name.

19. The system of claim 18, wherein the instructions that when executed by one or more processors results in the following additional operations comprising:
receiving an email to a target random email address from a sender domain, the target random email address comprising a target random email name and a privacy domain name;
identifying a target subscriber record based, at least in part, on the target random email name; and
providing the received email to a target subscriber email address associated with the target subscriber record if the sender domain corresponds to a target service provider domain name associated with the target random email name or selecting a response based, at least in part, on policy if the sender domain does not correspond to the target service provider domain name associated with the target random email name.

20. The system of claim 18, wherein the instructions that when executed by one or more processors results in the following additional operations comprising:
deleting the random email name and the service provider domain name from the subscriber record in the subscriber records store in response to a notice from a user device.
